(19) United States
(12) Patent Application Publication
(10) Pub. No.: US 2007/0046425 A1
(43) Pub. Date: Mar. 1, 2007

(54) Car security device

(76) Inventor: Irene F. Booth, Henderson, NV (US)

Correspondence Address: WEISS & MOY PC, 4204 NORTH BROWN AVENUE, SCOTTSDALE, AZ, 85251, US

(21) Appl. No.: 11/211,659

(22) Filed: Aug. 25, 2005

(51) Int. Cl. G08B 13/00

(52) U.S. Cl. 340/5.31; 307/10.5; 180/287; 340/5.65; 340/5.24; 701/32; 340/426.21

(57) ABSTRACT

A car security device designed to verify the driver's identity, ensure that the driver is insured, and communicate with police forces to check that the driver has no warrants before an individual is allowed to operate a vehicle. In the event of a high-speed pursuit, the car security device will control the speed of the vehicle.

### FIELD OF THE INVENTION

This invention relates generally to car security devices and, more specifically to a car security device using an authenticating memory card system and third party wireless communications to prevent unauthorized individuals from driving the vehicle.

### BACKGROUND OF THE INVENTION

Even today car theft remains a problem. A recent study found that in the United States a car is stolen, on average, every 25 seconds. Not only is car theft an important problem because of the loss of property and resulting insurance costs, but it also poses dangerous risks—often a stolen car is used for dangerous joy riding. Furthermore, a high-speed car chase may result if a car is stolen and the police pursue the stolen car.

This invention not only deals with the problems associated with car theft, but also those of invalid and uninsured drivers. Sometimes businesses will provide vehicles to their employees. These businesses do not want other individuals to drive their vehicles, Also, the businesses' insurance provider will often require that these drivers have specific training before they are allowed to operate the vehicles. Currently, no method exists for businesses to restrict vehicle usage to particular authorized individuals. If a company had that ability, they may be eligible for cheaper insurance.

Uninsured drivers also pose a serious problem. In an accident, an uninsured driver may cause hundreds of thousands of dollars worth of damage. Because the driver is uninsured, these costs fall on the innocent parties. If there were a mechanism that could ensure that an individual had insurance before they were able to start driving a car, drivers would not be exposed to the dangers of uninsured drivers.

Also, if a mechanism existed for checking warrants before an individual could operate a vehicle, the mobility of individuals with warrants would be greatly diminished. If an individual with a warrant attempted to operate a vehicle, the police could be alerted to the individual's location. As the individual would be unable to operate the vehicle, they would not be able to quickly flee that location.

Finally, in situations where individuals are driving vehicles at reckless speeds the police do not have many options. They are forced to either pursue the vehicle, which may result in a more dangerous situation, or let the individual go. If a mechanism existed that allowed police officers to remotely slow vehicles, the danger of high-speed collisions would be minimized.

Therefore, a need existed for a device that overcomes the above problems. The device would be able to verify the driver's identity, check that the driver is insured, and communicate with police forces to check that the driver has no warrants—all before an individual is allowed to operate a vehicle. There also existed a need for a device that could, in the event of a high-speed pursuit, control the speed of the vehicle.

### SUMMARY OF THE INVENTION

An object of the current invention is to provide a car security device. The car security device has a memory card reading device that is coupled to a driver management device. The driver management device is designed to store a list of authorized drivers. It can also compare data from the card reader device to see if the driver is authorized driver. The driver management device is coupled to a processor device. The processor device can use additional methods to determine whether the driver is authorized. It can communicate with a third party to see if the driver has any warrants or if the driver has current insurance. If the driver is authorized, the processor device will send a ‘start’ signal to the vehicle's OBD system; otherwise the processor device will not allow the engine to be started.

### BRIEF DESCRIPTION OF THE DRAWINGS

FIG. 1 is a block diagram showing the components of the car security device.

FIG. 2 is a flow chart diagram showing the car security device's authorization process.

### DETAILED DESCRIPTION OF THE PREFERRED EMBODIMENT

As shown in the Figures for purposes of illustration, the present invention is concerned with a car security device, generally designated in the accompanying drawings by the reference number 10.

The car security device 10 uses a memory card 12. The memory card 12 may be a standard driver's license with a magnetic strip, a dongle, keyfob or any other device that is both portable and capable of storing data. The memory card 12 is used to identify the individual who is currently attempting to operate the vehicle. Additional identification methods may be used without departing from the spirit and scope of the present invention. For example, a fingerprint or other biometric device could be used. Before a vehicle can be operated, a valid memory card 12 or other identifying device must be swiped through a memory card reader 14.

The memory card reader device 14 reads data from the memory card 12 and then sends the information to a driver management device 16. The communication may take place over a wired connection or the memory card reader device 14 may communicate with the driver management device 16 wirelessly. It should be noted that although the drawings indicate that an antenna is used for wireless communication, the wireless connection may be made in other ways. For example, the devices may communicate using an infrared signal. The driver management device 16 analyzes the data transmitted by the card reader device 14 to determine if it matches that of an authorized driver.

The driver management device 16 stores identifying information for drivers that are authorized to use the vehicle.

Drivers can only be added or removed from the driver management device 16 with the use of a master key 32. The master key 32 will be provided with the car security device 10. It should be noted that an alternative embodiment of car security device 10 may exist wherein the driver management device 16 does not perform any processing. Instead, the driver management device 16 could serve only as a storage device for data describing authorized drivers. A separate device would use the data to determine whether the driver is authorized. If the driver management device 16 determines that the driver is an authorized driver, driver management device 16 will pass the identifying information to a processor device 18.

After receiving the driver information from the driver management device 16, the processor device 18 can then perform further investigation to determine whether the driver is authorized. The processor device 18 can transmit relevant data (such as driver identification and current location) to a third party by way of general transmitter/receiver 20. The third party may then use the data to check that the driver is insured, registered, does not have any issued warrants, etc., The third party may then transmit relevant information back to the vehicle. The processor device 18 can use that information to determine whether it should allow use of the vehicle, or if it should not allow the vehicle's engine to run. It should be noted that the third party is not limited to only verifying that the driver is insured, registered, and does not have any issued warrants. The third party may perform additional analysis of the data transmitted by the car security device 10. For example, the third party may also check that the driver is authorized to use the vehicle at that particular time and location (location information is provided by GPS device 22 that is coupled to processor device 18). If the car is rented, the third party may check that the driver has paid to use the vehicle. Also, the third party that sends information back to the car security device 10 need not be the same third party to which information was sent originally. In fact, multiple third parties may receive and use the information sent by the car security device 10 and multiple third parties may send information back to the car security device 10. Finally, it should be noted that an alternative embodiment of car security device 10 could exist having no general transmitter/receiver 20 that would allow it to communicate with a third party. In that case, car security device 10 would only act to limit authorized drivers to the list stored in driver management device 16.

The general transmitter/receiver 20 may also be used to receive a speed-governing signal sent by a third party, such as a police officer. In the event of a high-speed chase, a police officer may transmit a code to the car security device 10 that instructs processor device 18 to slow the vehicle's speed. Although the drawings indicate the car security device 10 receives the signal by means of the general transmitter/receiver 20, it could receive the communication by a separate means such as an additional antenna or laser sensor. Also, it should be noted that an alternative embodiment of car security device 10 could be created that does not provide a speed-governing function.

The processor device 18 controls operation of the vehicle by means of an On Board Diagnostic system (OBD system) The car security device 10 has two OBD connections. A first OBD connection 24 allows the processor device 18 to be couple to the vehicle's OBD system. The processor device 18 can then send controlling signals to the vehicle's OBD system to control the vehicle ignition, maximum speed of the vehicle, and whether the vehicle's engine is allowed to run. It should be noted that processor device 18 is not restricted to only sending those control signals. Processor device 18 may send any valid OBD signal to the OBD system.

A second OBD connection 26 is also coupled to the processor device 18 acts as a bypass and allows a user to have access to the vehicle's OED system. However, the need for the second OBD connection 26 may be obviated if a user can access a vehicle's OBD system in a different manner. For example, if a user can access an OBD system wirelessly, there may no longer be a need for second OBD connection 26.

It should be noted that while the term ‘OBD system’ may refer to a specific vehicle diagnostics system, the car security device 10 could be configured to work with any vehicular control system that can receive electronic input. For example, the car security device 10 could be configured to interface with a car's computer controlled fuel injection system as a method of controlling whether a vehicle may be driven.

A diagnostics chip 28 is coupled to the car security device 10 and the vehicle's OBD system. The diagnostics chip 28 monitors all components of the car security device 10 and reports diagnostic data to the vehicle's OBD system by way of the processor device 18. Although the diagnostics chip 28 provides important information to a user, it is not a necessary element in car security device 10.

A power supply 34 is used to power the car security device 10. The power supply 34 may be the car battery, an external power supply, or the like. A backup power supply 30 is also coupled to the car security device 10. In the event that there is a power failure (possibly due to attempted theft) the backup power supply 30 provides enough power to the car security device 10 to allow it to communicate the car's current location to a third party. The backup power supply 30 is tamper resistant. Should an attempt be made to deactivate the backup power supply 30, the processor device 18 will have enough power to communicate the vehicle's current location to a third party or alternatively, send a signal to deactivate the ignition of the vehicle. In the future, the backup power supply 30 may provide car security device 10 sufficient power to perform a larger set of operations. An alternative embodiment of the car security device 10 may not contain the backup power supply 30. It may be the case that, as car theft decreases and battery reliability increases, the cost of the backup power supply 30 is not worthwhile. Also, the car security device 10 could be coupled to a car battery in such a manner as to make it nearly impossible to cut off the power supply.

Finally, a master key 32 will be provided with car security device 10. The master key 32 must be submitted to the card reader device 10 before the data stored by driver management device 16 can be altered. It should be noted that the master key 32 could take many different forms. Similar to the memory card 12, the master key 32 could be a standard ID style card with a magnetic strip, a dongle, a key fob or any other device that is both portable and capable of storing data. The master key 32 may even be a code that is typed to a keyboard coupled to the car security device 10. Any mechanism that requires a user to authenticate before modifying the list of authorized drivers stored in driver management device 16 would be sufficient.

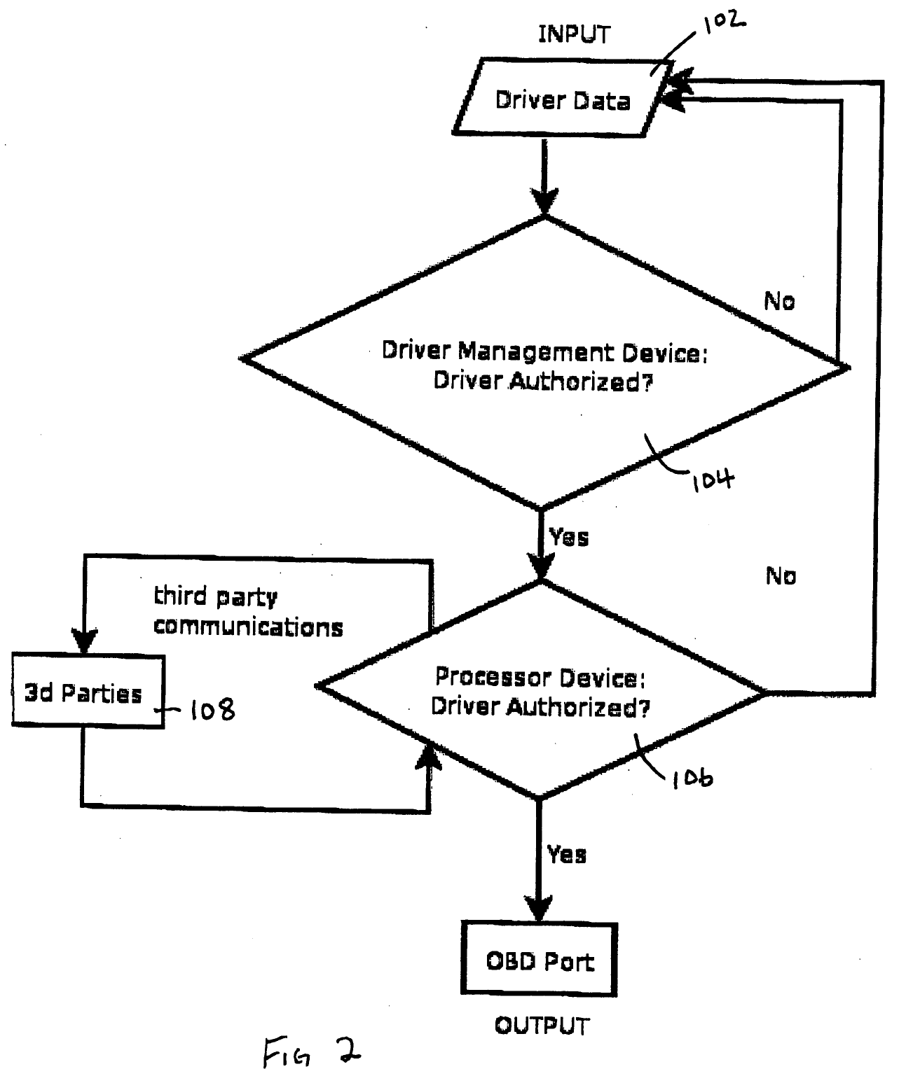

Referring to FIG. 2, a flow chart that describes the authorization process used by the car security device 10 is shown.

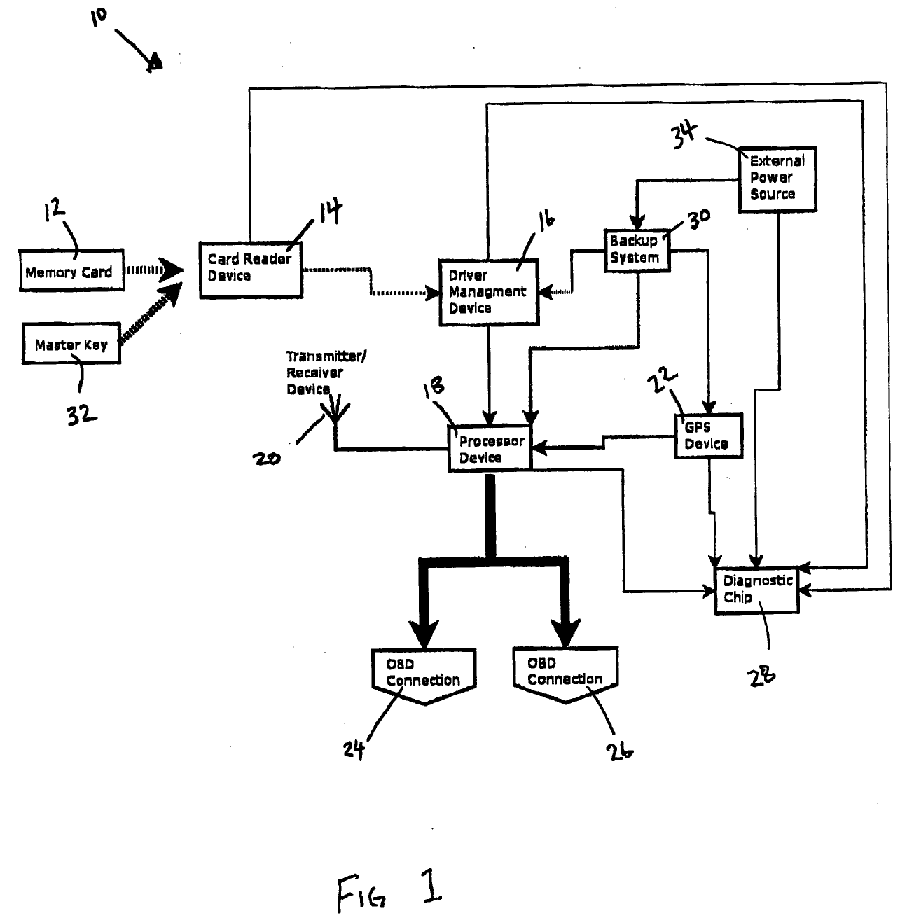

The driver data 102 is submitted to the driver management device 16 (FIG. 1) for an authorization step 104, The driver data 102 is any data that identifies the individual who is currently trying to operate the vehicle. In general, the driver data 102 is stored on a memory card 12. However, the driver data 102 may be information that is stored on a driver's license, a dongle, keyfob, or a fingerprint. The driver management device 16 compares the driver data 102 to a list of authorized drivers stored in the driver management device 16. If the driver data 102 matches that of an authorized driver, the driver management device 16 sends the driver data 102 to a processor device 18 (FIG. 1) step 106. The processor device 18 may then communicate with the third parties 108 to determine whether the driver is authorized to use the vehicle. The information sent to the third parties 108 may include driver data, current vehicle location (provided by GPS device 22), current time, vehicle identification information (such as the vehicle's license plate, type and color) etc. The third parties 108 may be a police force that checks to see whether a driver is authorized to use a particular vehicle (the individual may only have a suspended license or have warrants out for his or her arrest). The third parties 108 may also be an insurance agency that can check to see that a driver is fully insured or licensed to operate a particular class of vehicle. It should be obvious that processor device 18 could send many different packets of data to many different third parties 108. Depending on the information transmitted back to processor device 18 from the third parties 108, the processor device 18 can determine whether a driver is authorized to operate the vehicle. If the driver is authorized, the processor device 18 will transmit a signal to an OBD Port 24 allowing the vehicle to operate.

While the invention has been particularly shown and described with reference to preferred embodiments thereof, it will be understood by those skilled in the art that the foregoing and other changes in form and details may be made therein without departing from the spirit and scope of the invention. Car security device 10 may send control signals to the vehicle by a different means than the vehicle's OBD system. As an example, processor device 18 may be coupled directly to the computer system that controls the vehicle, Alternatively, a proprietary system may be developed to allow car security device 10 to control the vehicle.

I claim:

1. A car security device comprising:
a card reader for reading data from a memory storage card;
a driver management device coupled to said card reader and capable of storing identifying information of authorized drivers and comparing said identifying information of authorized drivers with said data retrieved from said memory storage card; and
a processor device coupled to said driver management device for one of sending a start signal if a driver is authorized to use the vehicle or a deactivation signal if the driver is unauthorized, preventing the vehicle from operating.

2. The device of claim 1 wherein said processor device is further coupled to an OBD (On Board Diagnostics) system of the vehicle, said processor device capable of sending control signals to the OBD system of the vehicle thereby allowing said processor device to control at least one of vehicle ignition, maximum speed of the vehicle, and running of an engine of the vehicle.

3. The device of claim 1 further comprising a wireless communication device coupled to said processor device, said wireless communication device transmits and receives information to and from a third-party to determine if said driver is authorized to use the vehicle.

4. The device of claim 1 further comprising a GPS device coupled to said processor device, said GPS device providing location data to said processor device.

5. The device of claim 1 wherein said card reader device and said driver management device communicate wirelessly.

6. The device of claim 1 further comprising a diagnostic chip coupled to said car security device, said diagnostic chip for checking and reporting status information of said car security device.

7. The device of claim 6 wherein said diagnostic chip is coupled to an OBD system of the vehicle for reporting status of said car security device.

8. The device of claim 1 wherein said car security device is coupled to a battery of the vehicle.

9. The device of claim 8 further comprising a backup power supply coupled to said car security device, said backup power supply for providing power to the car security system in the event that a car battery power supply becomes unavailable.

10. The device of claim 1 further comprising a first OBD connection having a first end and a second end, said first end is coupled to said security device and said second end is coupled to an OBD system of the vehicle, said first OBD connection for allowing said car security device to couple to an OBD system of the vehicle.

11. The device of claim 10 further comprising a second OBD connection being coupled to said car security device, said second OBD connection for providing OBD system information to a third party.

12. The device of claim 1 further comprising a master key card to be read by said card reader device to alter identifying information in the driver management device.
